(19) United States
(12) Patent Application Publication
(10) Pub. No.: US 2007/0044156 A1
(43) Pub. Date: Feb. 22, 2007

(54) Method and apparatus for verifying firewall and router configuration for peer-to-peer applications

(75) Inventor: William Gibbens Redmann, Glendale, CA (US)

Correspondence Address: William G. Redmann, 1202 Princeton Dr., Glendale, CA, 91205, US

(73) Assignee: eJamming, Inc., North Hollywood, CA (US)

(21) Appl. No.: 11/506,474

(22) Filed: Aug. 18, 2006

Related U.S. Application Data
(60) Provisional application No. 60/709,670, filed on Aug. 19, 2005.

(51) Int. Cl. G06F 11/00

(52) U.S. Cl. 726/25

(57) ABSTRACT

A method and apparatus are disclosed that test the configuration of routers and firewalls interposed between a computer on which an application runs and a network, and determine if the configuration is suitable for the application to operate correctly. When the configuration is not correct, appropriate advice is given.

### CROSS REFERENCE TO RELATED APPLICATIONS

This non-provisional patent application claims the benefit under 35 USC 119(e) of the like-named provisional application No. 60/709670 filed with the USPTO on Aug. 19, 2005.

### FIELD OF THE INVENTION

The present invention relates generally to a system for testing the configuration of network routers and firewalls. More particularly, the invention relates to a system for permitting would-be users of peer-to-peer networking software to verify the configuration of their routers and firewalls.

### STATEMENT REGARDING FEDERALLY SPONSORED RESEARCH OR DEVELOPMENT

Not Applicable

### REFERENCE TO COMPUTER PROGRAM LISTING APPENDICES

Not Applicable

### BACKGROUND OF THE INVENTION

Many households today are connected to the Internet. New offerings such as broadband over power lines and ubiquitous wireless are proposed. While these may ultimately alter the typical household network configuration, with the vanishing exception of a dial-up modem, a home network typically comprises a single DSL or cable modem connected to one or more computers wirelessly and/or by Ethernet.

Most households are provided by their Internet service provider (ISP) with a single Internet Protocol (IP) address. If a single computer is directly connected to the DSL or cable modem, it can respond directly to this IP address. However, if one or more computers connect to the modem through a router, which may be integrated into the modem, then IP address translation takes place. Each computer on the household local area network (LAN) side of the router has a distinct IP address for use on the LAN. However, on the Internet, or wide area network (WAN) side of the router, the router responds to the single IP address on the Internet assigned by the ISP. Communication between a computer on the LAN and other computers on the Internet is enabled by the router translating LAN addresses on outbound messages into the assigned WAN address, and reversing the process when the router receives a response.

For instance, consider the example of a computer running a web browser on a household LAN having a router, which wishes to visit a web site, say, www.ejamming.com. The following description is somewhat simplified, and complete details can be obtained from authoritative references, such as TCP/IP Illustrated Volume 1, by W. Richard Stevens, published by Addison-Wesley Publishing Company, Reading, Mass., 1994 and RFC 1631—The IP Network Address Translator, published by Network Working Group, 1994.

First, when the computer was booted, it either had a file containing its network configuration (a manual configuration), or it called for assistance to automatically determine its network configuration, for instance using the DHCP protocol. In a household LAN, one of the router and modem would typically have answered this call, and the computer would have obtained its LAN IP address and other configuration information from the response. The configuration information includes the router address, subnet mask, and domain name server (DNS) address, each discussed below.

Second, once the browser launches, the user requests to visit www.ejamming.com. The computer now needs to find out the IP address of the web site. Generally, the address isn't stored locally unless the site was recently visited, so the computer will request the information from the DNS, whose address was provided as part of the network configuration. Further, the computer will recognize that the DNS address is not on the LAN, since it is outside the subnet determined by masking the LAN IP address with the subnet mask. Therefore, though the computer addresses the request to the DNS and specifies port 53 (the well-known port for DNS requests), the computer directs the request to the router. The computer includes its own LAN IP address as a return address.

The router, upon receiving a request not addressed to it, will forward the request. However, the router recognizes that the LAN IP address is not a valid address on the WAN, and needs to perform a network address translation (NAT). The router replaces the return address supplied by the computer with the router's WAN address, the one supplied by the ISP. Further, the router remembers the destination address and port of the request, and the original port and LAN IP address from which the request was sent, so that it can recognize and NAT the reply. The translated request is then forwarded onto the Internet.

Generally, the request reaches the DNS which looks up the IP address of the name given, and composes a response, in this case that 66.132.132.139 is the IP address for www.ejamming.com. The response is sent back through the Internet using the return address and port used by the router.

When the response arrives at the router, it recognizes that the message addressed to the port from which the request was sent, and has the DNS address and port listed as the sender. This provides enough information for the router to recognize this message as the response to the earlier request. The destination address and port on the message is overwritten with the LAN IP address of the computer (the original requester) and the port the computer used to issue the request. With the translation complete, the message is forwarded to the computer on the LAN.

Upon receiving the reply to its DNS request, the browser now knows the IP address for the web site. The browser composes a GET command in the HTTP protocol, and addresses it to port 80, the well-known port reserved for HTTP, on the IP address 66.132.132.139. As before, the IP address is recognized as not being on the subnet, and so the message is directed to the router.

Again, the router realizes that the LAN IP address of the computer is inappropriate for use on the Internet, and so performs the NAT, remembering the originating computer address and port and the remote server's destination address and port.

Without going into the details of the transmission control protocol (TCP), in essence the reply from the web site is returned to the router as a sequence of packets. Each packet is recognized as a response to the previous request that had undergone outbound NAT, and so each is subjected to the inbound NAT and forwarded to the computer.

The value of the router performing the NAT procedure on outbound requests is that more than one computer can simultaneously make use, not only of the same IP address, but even of the same remote server. For instance, several computers on the household LAN can simultaneously visit the www.ejamming.com web site, and the NAT procedure implemented by the router directs responses to each computer's query to the correct computer.

However, there is a drawback.

Modern video games commonly support multiple players. While a household may have multiple platforms capable of networking with each other to play such games, more common is the use of the Internet to connect with players at remote locations.

Multi-player video games require that each gaming station at least partially share model of the game environment. Some games employ central servers with which each player connects. The central server provides a clearinghouse of game environment information, which each player's station may access. In this arrangement, NAT works in a manner similar to the web site example, above. Multiple computers on the household LAN can each participate in their own connection to the central game server.

However, central game servers represent a significant expense for game companies. It is much more economical for multi-player games to employ peer-to-peer configurations. A central server, called a ‘lobby’, is only used to organize a game, but once the game starts all of the players' game stations are in direct communication with each other. NAT does not work so well here.

In peer-to-peer games, the lobby server informs each game station of the other game stations' IP addresses. If a NAT were used, these would be the WAN address of the NAT router. Each game station attempts to contact the others by sending a message to the IP address received from the lobby server, and directing it to whatever port the game prescribes for inter-station communication.

NAT fails here because the inter-game communication message arrives bearing an unfamiliar IP address and port. There is no record of an outbound message matching the parameters of this unsolicited inbound message. The router doesn't know where to send this message.

Enter port forwarding. Many routers can be programmed so that messages addressed to a specific port are forwarded to a specific computer on the LAN. For instance, if one of the computers in a household was intended to be a web server, then that computer's LAN IP address would be identified to the router as the address to which messages sent to port 80 (the well-known port for HTTP) should be relayed. A browser out on the Internet would send a GET message to the IP addresss assigned by the ISP, port 80, and upon receiving it, the router would rewrite the destination as the identified computer and direct the message accordingly.

Unfortunately, even with advances in router configuration software, many users find that configuring a router for port forwarding (or its advanced cousin, port triggering), is a task unreliably performed. Compounding this is the fact that many peer-to-peer games require multiple ports to be so forwarded.

The difficulty lies in that successful configuration of a port forwarding router can't be tested from within the LAN. A player learns that the router has been correctly configured only when the router responds to an external message directed at the designated port while the game is running. If the game plays, then the router is configured correctly. If the game doesn't play, the maybe the router isn't configured correctly—it could be that another player's router is misconfigured. However, it is common that if another player's router is misconfigured, he doesn't get an error message. He can send messages just fine. You can't send messages to him, though. You get an error message for his mistake.

A primary complaint regarding port forwarding in multi-player games is that a player with an improperly configured router is directed by the lobby to join games, which then fail because the router isn't configured to support the necessary peer-to-peer connection.

An additional difficulty occurs because different games usually require different ports. A port-forwarding configuration that works for one game, usually doesn't work for another. For instance, America's Army, a massively multi-player simulation game by the United States Army requires UDP ports 1716, 1717, 1718, 8777, 27900, and TCP ports 14200, 20045; but Battlefield 2 by Electronic Arts, Inc. of Redwood City, Calif. requires UDP ports 1024-1124, 1500-4999, 16567, 27900, 28910, 55123-55125 and TCP ports 80, 1024-1124, 4711, 29900-29901 (source: www.portforward.com by Dave Clark of Grants Pass, Oreg.).

Another confounding factor in peer-to-peer games is firewalls. Because of the need for security against the many threats posed by the Internet, it is common for computers to run firewall software, such as eTrust EZ Firewall by Computer Associates, Inc. of Islandia, N.Y. Such firewall software intentionally blocks network activity for applications not having prior permission to access or offer services to the Internet. When a computer is running firewall software and a peer-to-peer game is failing to connect, it could be that the router is correctly configured for port forwarding, but that the firewall is disallowing the connection.

Yet another issue troubling peer-to-peer connections in computer games is that, more often than not, the user is a child or young adult having little formal training in network administration. This suggests the additional requirement that any solution provided to the above issues be both easy and foolproof.

### OBJECTS AND SUMMARY OF THE INVENTION

There exists a need for a way to manage the requirement of a game application to have one or more specific ports in one or more protocols forwarded.

There is a further need for a way to address the inability of a user to reliably and conveniently verify a router's port forwarding configuration for the appropriate array of ports.

An additional need exists for a way to confirm that a firewall (if present) is appropriately configured to allow a game application appropriate network access.

There exists a need for a system and method to easily confirm the readiness of a computer and LAN to participate in a multi-player game, before a lobby server directs the computer to join a game, thereby disrupting the enjoyment of individuals with correctly configured equipment.

A further need exists to provide diagnostic information to a player, to facilitate the configuration of firewalls and routers necessary for the successful participation in peer-to-peer games.

The present invention satisfies these and other needs and provides further related advantages.

The present invention relates to a system for testing for the correct configuration of network routers and firewalls that might otherwise interfere with operation of an application. More particularly, the invention relates to a system for permitting would-be users of peer-to-peer networking software, such as games, to verify the configuration of their routers and firewalls.

Upon launch, an application offering network services to other computers via the Internet, initiates a sequence of tests to determine whether each required port can correctly access and/or be accessed from other stations on the Internet. An example of such an application would be a peer-to-peer multi-player game.

The required tests are conducted with the aid of a test server accessed through the Internet. Preferably, the test server is configured to perform the appropriate tests by the request itself, for instance by requesting a particular URL, or by accepting a parameter string. Alternatively, the test server can be configured only for a specific application, and implement only the tests pertinent to that application.

During the testing sequence, any identifiable failure generates specific information to direct the user in correction of the problem. To the extent that any identifiable success is recognized, it is recorded. To the extent that unidentifiable failures have occurred, suggestions for diagnostic steps, preferably selected in light of any recorded successes, are presented.

If any required tests result in failure, the user is given the opportunity to attempt to correct the problem, find additional help, or to retry the test.

Once all required tests are successful, the application continues operation.

It is an object of this invention to manage the network requirements of an application, especially a game application. In particular, one which requires external Internet access to one or more specific ports in one or more protocols.

It is a further object of this invention to provide reliably and conveniently verify for a user that a router is configured to forward the appropriate array of ports.

Still another object of the present invention is to confirm that a firewall, if present, is appropriately configured to allow the application the necessary network access.

This invention has as a further object easy confirmation that the computer and LAN are ready to participate in a peer-to-peer network application, especially a multi-player game, before other such computers are directed the join with it, as by a lobby server, thereby disrupting the enjoyment of other individuals having correctly configured equipment.

Another object if this invention is to provide diagnostic information to a user to facilitate the configuration of firewalls and routers necessary for the successful participation in network application, especially peer-to-peer applications, and in particular, games.

These and other features and advantages of the invention will be more readily apparent upon reading the following description of a preferred exemplified embodiment of the invention and upon reference to the accompanying drawings wherein:

### BRIEF DESCRIPTION OF THE DRAWINGS

The aspects of the present invention will be apparent upon consideration of the following detailed description taken in conjunction with the accompanying drawings, in which like referenced characters refer to like parts throughout, and in which:

FIG. 1 is a detailed block diagram of multiple computers configured to interact over the Internet, with appropriate servers;

FIG. 2 is a flowchart of the testing process as performed by a target computer;

FIG. 3 is a flowchart of the testing process as performed by a test server; and

FIG. 4 is an example message exchange between a target computer and a test server.

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

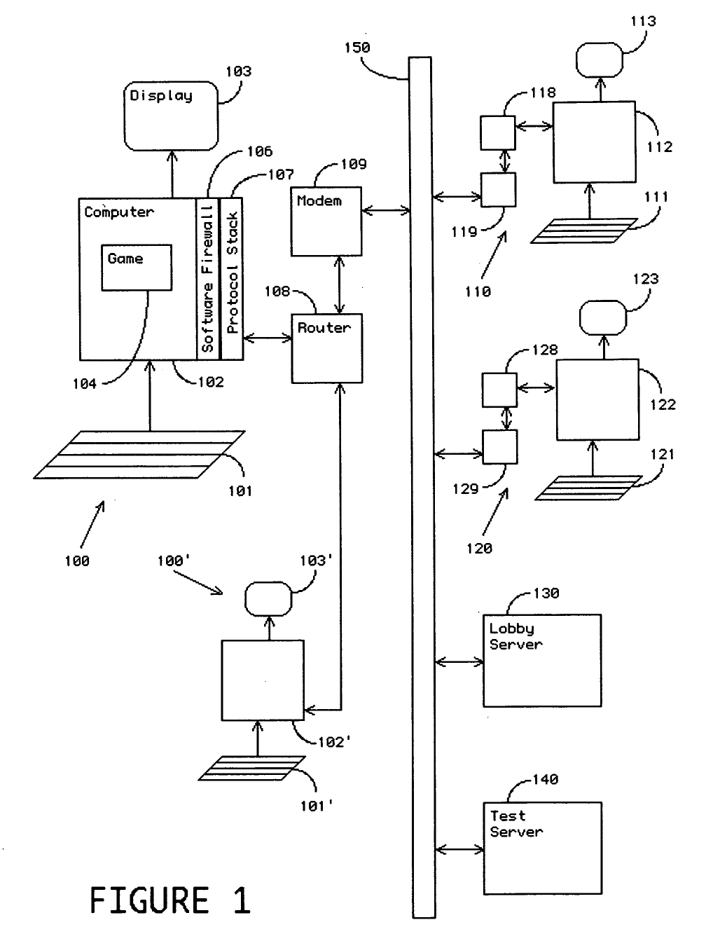

Referring to FIG. 1, a plurality of stations 100, 110, 120, lobby server 130, and test server 140 are interconnected by communication channel 150.

For clarity, lobby server 130 and test server 140 are shown as separate devices. It will be readily understood that the functions discussed below could be provided by a single server, or distributed among a different number of servers.

For some implementations, a central server (not shown) may be used, as in massively multi-player games where a central, authoritative world model database is needed to provide world status to all participating computers. As above, the central server may be a discrete entity, or one aspect of a server that also provides the functions of lobby server 130 and/or test server 140. While the present invention does contemplate operating with such a central server, the central server is not required for operation and is not discussed beyond this mention.

Communications channel 150 may be comprised of many pieces, including a telephone network, a local or wide area Ethernet, the Internet, or any other communications medium. It may include wireless segments. The key property is that it allows intercommunication among stations 100, 110, 120 and between those stations and servers 130 and 140

In FIG. 1, each of remote stations 110 and 120 substantially mirror the elements of local station 100, and optional additional local station 100′. Each of stations 100, 100′, 110 and 120 have keyboard and controls 101, 101′, 111, 121, computer 102, 102′, 112, 122, display 103, 103′, 113, 123. Both local stations are connected through router 108 to modem 109 and so to communication channel 150. Remote stations 110 and 120 connect through routers 118 and 128 to modems 119 and 129, respectively, and so to communication channel 150.

In some embodiments, a modem and router may be integrated into a single device (not shown). Also, some embodiments can provide computer 102 with a native physical connection to communication channel 150, without intervening modem 109.

In other embodiments, without additional local station 101′, computer 102 can connect directly to modem 109 without the intervening router, or may connect directly to communication channel 150 if a native physical connection is available.

For purposes of convenient reference, the communication channel will be subsequently referred to as the Internet 150, but it will be understood that such a reference includes all the potential modes of interconnection previously discussed, including embodiments where the Internet is not part of the interconnection.

It is well known that stations 100 and 100′ could share a common display, keyboard, and controls, with a switch (not shown) to select to which station the common devices (not shown) are currently connected.

Computer 102 comprises a protocol stack 107, as do computers 112, 122 and servers 130 and 140, to manage communications among themselves.

An appropriate security precaution is for each computer 102, 112, and 122 to have a firewall, such as the software firewall 106. However, though they are strongly advised in any circumstance, firewalls are optional to the practice of this invention. Hardware firewalls (not shown) are well known in the art, and can be used in lieu of or additional to software firewalls, such as 106. Appropriate connection to such a firewall is also well known.

Computer 102 is able to run application 104, which may be a game or other application requiring network access of a type to be confirmed by use of the present invention.

Without using the present invention, application 104 would attempt to contact lobby server 130 through software firewall 106, protocol stack 107, router 108, modem 109, and Internet 150. If contact could be made, lobby server 130 would inform application 104 of station 110, running compatible software and hosting a session of interest to application 104 (or the application's user, not shown).

Application 104 would then attempt to contact station 110 through the same intermediaries 106, 107, 108, 109, and 150, and additional remote intermediaries modem 119, router 118, protocol stack (not shown) and firewalls (neither shown).

If contact could be made with station 110, application 104 would be informed that station 120 is already participating in the session and direct application 104 to attempt contact with station 120. Alternatively, station 110 might inform station 120 that station 100 is joining, and direct station 120 to contact station 100.

Regardless of the direction, one of stations 100 and 120 attempt to contact the other through the path comprising firewall 106, protocol stack 107, router 108, modem 109, Internet 150, modem 129, router 128, and the protocol stack (not shown) and any firewall (not shown) of station 120.

If all elements of all these interconnections are correctly configured to cooperate and admit the necessary communications, then application 104 on station 100 will be successful in joins the session hosted by station 110, which includes station 120 as a participant.

However, configuration of those pieces of equipment is both complex, and the responsibility of the party operating the respective stations and servers. While the configuration of lobby server 130 is expected to be administered by information technology professionals, and is therefor very likely to be correct, the same is not true for stations 100, 110, and 120. This is especially true in the context where application 104 is a game, because the party operating each station is likely to not be an information technology professional.

The drawback of failing to achieve any of the connections discussed above goes beyond an inconvenience to the operator of station 100, who at least is denied successful access to the session. Depending on which connection failed, and why, the operators of host station 110 or participating station 120 may also be inconvenienced. Either or both of their experiences could be disrupted. Data may be lost. Further, the operator at station 100 is not necessarily informed as to the nature of the failure, and even if fully informed, may misunderstand the implications.

Regardless, application 104 may revisit lobby server 130 and proceed to identify and subsequently wreak havoc with another session. Alternatively, if the source of the configuration problem wasn't station 100, a subsequent attempt to join a different session may succeed. However, the session being hosted at station 110 would never advance past its current occupancy, because of a faulty configuration at stations 110 or 120.

Such complex situations are difficult to diagnose. Any of several potential configuration faults might deliver identical failure messages to a user. Also, a configuration fault at one station might result in failure messages at a remote station.

For instance, suppose application 104 is required to listen for remote contact on a port X in protocol stack 107. When application 104 joins the session hosted by station 110, station 120 receives an instruction to contact station 100 on port X. A number of things can go wrong here:

First, software firewall 106 may disallow application 104 opening port X on protocol stack 107;

second, router 108 may not be configured to forward port X at all;

third, router 108 may be configured to forward port X to additional computer 102′;

fourth, a firewall at station 120 may prevent the protocol used from leaving station 120;

fifth, a firewall at station 120 may block access to an outbound port by the application running on computer 122;

sixth, the router 128 may not be configured to advance the instruction from station 110 to computer 122; etc.; or,

more than one of the above, or others (which depend upon configuration).

The present invention operates primarily by ensuring that a station, such as 100, is properly configured for application 104 before it contacts lobby server 130 and attempts to join or host any sessions.

Note that in the prior discussion, the use of lobby server 130 is well known, as are alternatives, for instance where station 110 hosts its own lobby, as well as the session. In that embodiment, instead of contacting lobby server 130, application 104 would either be informed or preconfigured with information necessary for contacting station 110. This, and other methods for arranging a session between two or more computers, are well known to those practicing the art, and this invention contemplates their use.

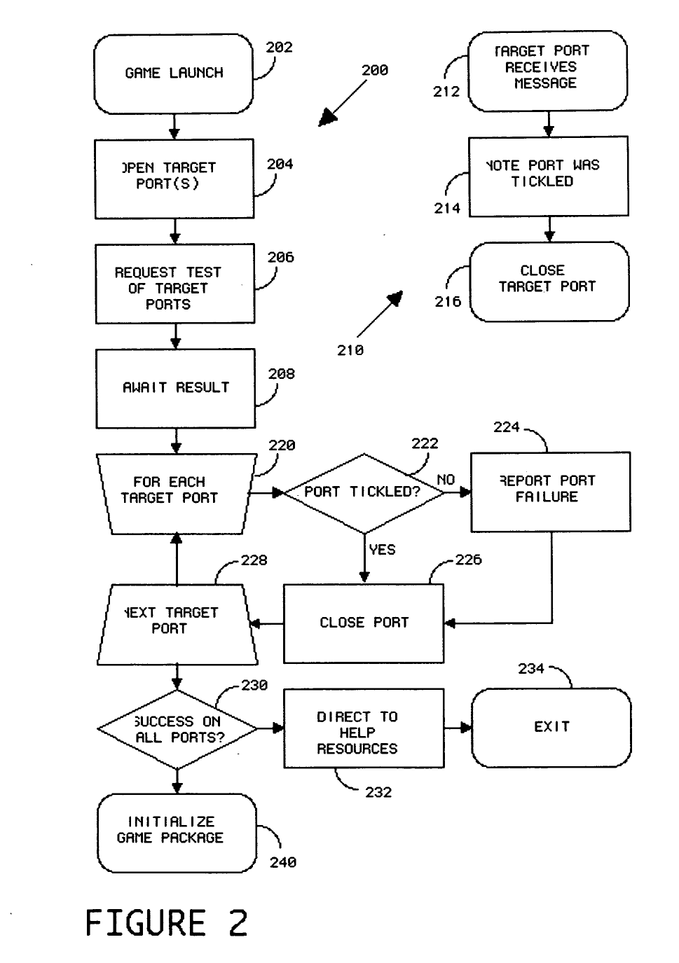

Referring to FIG. 2, one embodiment of the present invention, in this case implemented as process embedded in application 104, is shown.

In the following discussion, “target ports” are those ports that would be used by application 104 in normal operation.

Target test process 200 is initiated upon the launch of application 104 at step 202.

Initially, target test process 200 attempts to open the target ports that will later be used by application 104. A failure to open one or more ports is noted for subsequent reporting, as in step 232 below, or, in the alternative, immediate reporting.

Also, for each port opened for testing a monitor process 210 is initiated. Each monitor process 210 awaits an inbound message on its corresponding target port. When such an inbound message is received in step 212, a record of the contact is made in step 214, and monitor process preferably closes the corresponding target port in step 216, and terminates.

In step 206, test server 140 is contacted. Preferably, the attempt to contact test server 140 is made using protocols selected to be the most likely to be acceptable to firewall 106 and router 108. A good choice for this protocol is HTTP over TCP/IP, which is commonly enabled in situations where computer 102 uses an Internet browser. Once contact is made, test server 140 is requested to test the target ports.

The request to test the target ports may comprise an explicit list: Comprising each port or range of ports to be tried, and for each, the one or more protocols to be attempted.

Preferably, the request to test the target ports is implicit. This can occur in two ways. One way is for application 104 to present identification in the request, with which test server 140 retrieves a predetermined list, having details similar to those above, of target ports corresponding to that identification. Alternatively, test server 140 is preconfigured to use a single predetermined list of target ports.

One advantage of having implicit, predetermined target ports is that test server 140 is less prone to exploitation by an unauthorized or malicious application (not shown) running on computer 102 seeking to conduct tests to search for vulnerabilities in computer 102.

Preferably, the protocol used to contact test server 140 allows test server 140 to determine the address of station 100. If not, the address of station 100 must be provided within the request.

Once the request for testing has been issued to test server 140, computer 102 preferably awaits the results of inbound testing in step 208. While computer 102 awaits the results of inbound testing in step 208, test server 140 performs the tests of the target ports requested.

Step 208 concludes when results are received from test server 140, which may be a mere acknowledgement that testing has concluded.

Alternatively, step 208 may conclude upon detection that testing is complete. Such a detection may be performed by noting that all target ports opened in step 204 have been closed in corresponding steps 216 as a result of having received messages from test server 140.

Also, step 208 preferably incorporates a timeout value, such that if results have not been received or the conclusion of testing detected within a predetermined amount of time, step 208 concludes anyway.

Step 220 selects one of the target ports as the current target port. In step 222, a determination is made whether this port had received a message from the test server in corresponding step 212. The determination can be made on the basis of a note made in corresponding step 214, or by whether the port has already been closed in a corresponding step 216. This determination also considers a failure to open the target port, if noted in step 204.

If step 222 determines that the selected target port or communication thereto has not functioned as required, the failure is reported in step 224.

If not already closed, the selected target port is closed in step 226. Also in step 226, any corresponding monitor process 210, if still running, is terminated.

If unevaluated target ports remain, then step 228 loops back to step 220, where one of the remaining target ports is selected, but if all target ports have been evaluated, then target test process 200 continues at step 230.

If step 230 finds that testing of all target ports has been successful, then target test process 200 concludes and control can pass to the balance of the application in step 240.

To the extent that communication failed on any of the target ports, processing continues to step 232, wherein the identity of the port and the nature and likely causes of the failure are identified.

For instance, if application 104 requires UDP communication inbound on port :6500 (with a colon proceeding a number indicating a port number throughout) and though port :6500 was successfully opened in step 204, test server 140 was successfully contacted in step 206, and a response received in step 208, but no message was received in corresponding step 212, then causes which can be eliminated include a) the port was in use by another application, b) an inability to access the Internet 150 (e.g., because of a missing physical connection), and c) firewall 106 is disallowing application 104 from connecting to protocol stack 107 on at least the inbound UDP protocol. Further, if UDP communication inbound on port :2300 was successful, then additional causes are eliminated, such as d) that router 108 is not forwarding any UDP traffic to computer 102.

The remaining possibilities are noted, such as e) the router 108 is not forwarding UDP port :6500 to computer 102. If more than one possibility exists, each is listed preferably in order of likelihood, or alternatively, in order of ease of examination.

Elimination of possible causes is well known in the art, for example in the form of a diagnostic tree. A specific class of configuration error will result one or more corresponding specific classes of failure. To the extent that any success achieved during testing eliminates one or more classes of failure, any class of configuration error that implies that same class of failure ceases to be a candidate configuration error for remaining failures.

Presentation and subsequent elimination of configuration error possibilities usually converge quickly on the actual cause or causes. Preferably, the presentation of the remaining possibilities is in the form of a troubleshooter, well known in the art, which leads a user step-by-step through the remaining possibilities to be checked.

Preferably, advice for correcting this specific difficulty is presented. Such advice may take the form of opening context sensitive help, well known in the art, or a clickable link to resources teaching the configuration of port forwarding on various makes and models of routers, such as those offered by Dave Clark of Grants Pass, Oreg. through his www.portforward.com site.

If a correction is made by the user during step 232, repeating the target test process 200 by looping back to step 204 (loop not shown) can be performed quickly. Alternatively, application 104 can exit at step 234.

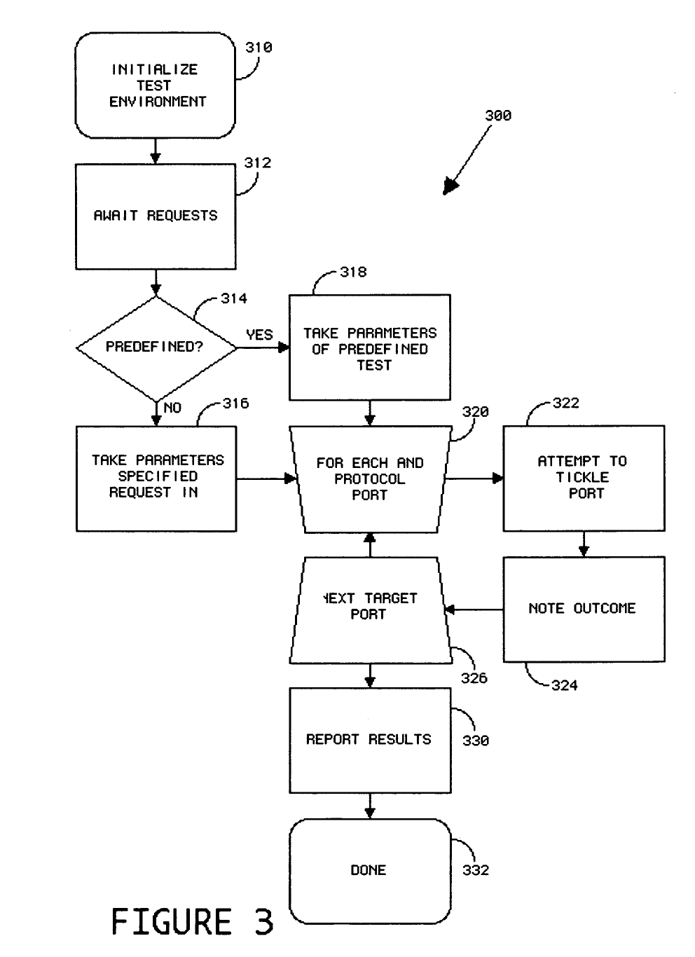

FIG. 3 illustrates server test process 300, running on test server 140. Server test process 300 is the companion to target test process 200.

Test server 140 is ready to run server test process 300 as soon as step 310 has been performed.

If the request in step 206 uses the preferred implementation for HTTP protocol over TCP/IP at port :80 (the well-known port for standard HTTP), then testing server 140 can be embodied as a standard web server upon which step 310 is performed by providing a program implementing the balance of server test process 300 and placing that program in a location suitable for execution by the web server upon request. The request of step 206 would comprise the URL of that program, and such parameters, if any, as have been previously described.

The request of step 206 is received by test server 140 in step 312.

Step 314 determines if the parameters of the test to be conducted are predefined. If the parameters are predefined, they are retrieved in step 318. If the parameters are constant, then control passes to step 320. However, if the parameters differ according to the identity of application 104, then that identification, received in step 312 as a parameter of the request issued in step 206, is used to lookup the appropriate, predetermined test parameters.

However, if step 314 determines that the test is not predefined, the parameters of the test are extracted from the request.

Once the parameters are determined, step 320 selects a test to be performed, according to the parameters.

As in the previously discussed example, if application 104 requested (implicitly or explicitly) that inbound UDP port :6500 be tested, then in step 322, test server 140 would open a UDP port and send a datagram to the address of station 100, port :6500. The nature of UDP, by design, is that the success or failure of a datagram cannot be reliably determined by the sender. As such, test server 140 and server test process 300 would typically note merely that the packet was sent in step 324. However, if the request being fulfilled were for connection to a TCP port, then a considerably more thorough outcome report would be generated.

If any elements of the request remain to be fulfilled, step 326 will loop back to step 320 and select a new port to test, otherwise control passes to step 330.

In step 330, the outcomes recorded in step 324 are collected and returned to application 104, preferably as an HTTP response. Generally, application 104 receives the response in step 208, after which server test process 300 terminates in step 332, effectively returning to the waiting status of step 312.

In an alternative embodiment, when sufficient concern exists that the configuration of station 100 might permit outbound access to test server 140, but not outbound access on other less common ports, steps can be added to target test process 200 to test the operation of outbound ports. To do this, the request of step 206 may include a list of outbound ports and protocols to be tested. In this embodiment, server test process 300 would perform step 204 (not shown in process 300) for the outbound ports identified in step 206, and would initiate a corresponding process 210 on test server 140, for each outbound port requested. Once process 300 had completed its own step 206 (not shown) and initiated corresponding processes 210, an acknowledgment would be sent to application 104. Alternative target test process 200 will have waited in for this acknowledgment, and upon its receipt will execute its own version of the loop comprising steps 320, 322, 324, and 326, using the loop to drive the testing of the outbound ports required by application 104. The alternative embodiment of target testing process 200 would also report completion of this loop with its own version of step 330, before proceeding on to step 208. To complete this alternative embodiment, server test process 300, upon exiting from the loop at step 326 would await the report of completion from alternative target test process 200 in its step 330. Upon receiving this, server test process 300 would execute its own versions of the loop comprising steps 220, 222, 224, 226, and 228. The results of step 224 in alternative server test process 300 would be included with the results reported in step 330.

This alternative configuration of test processes 200 and 300 is more compactly described here: Application 104 readies for inbound tests. Application 104 requests certain inbound and outbound tests. Test server 140 readies for the requested outbound tests (added step 204), then acknowledges the request. After the acknowledgment, application 104 conducts the outbound tests from computer 102 (added steps 320, 322, 324, 326), and test server 140 conducts the inbound tests to computer 102 (original steps 320, 322, 324, 326). These loops can proceed asynchronously. Application 104, upon completion of the outbound tests, reports the completion to the test server 140 (added step 330). Test server 140, upon completion of inbound tests (original steps 320, 322, 324, 326), awaits the report that the outbound tests are complete. Upon receipt, test server 140 examines the outbound test results (added steps 220, 222, 224, 226, 228), and combines the results obtained to the report sent to application 104 (original step 330).

If the unreliable nature of packet delivery over Internet 150 is significant concern, tests relating to UDP ports can be repeated if they fail a first, or even second time. For instance, an outer loop can be added to target test process 200 so that if in step 230 a first-time failure is detected in a one or more UDP ports (and the failure did not originate while in step 204), then the process can loop back to step 204 to retest those ports. If after a second attempt the status of the failed UDP ports is unchanged, the failure is processed as before in step 232. This loop is not needed for TCP ports, since their implementation already includes a retry mechanism.

An alternative embodiment to the preferred embedding of target test process 200 in application 104, would be for the target test process 200 to reside in a separate application (not shown) that executes the tests as described above, wherein step 240 sets a flag or otherwise grants permission to application 104 to proceed. However, this embodiment may render certain misconfigurations undetectable, for instance, firewall 106 may be configured to allow the test application (not shown) to access a certain port, but disallow application 104. It can also provide false positives for other misconfigurations, such as firewall 106 being configured to disallow the test application to access certain port, but allow access by application 104. These and other embodiments falling within the teachings this description will be apparent to those of ordinary skill in the art.

Optionally, test server 140 may be multi-homed (not shown), so that the testing of target ports can be conducted from an address other than the one at which the test server 140 was contacted in step 206. The may be necessary to verify the correct configuration of certain more sophisticated firewalls.

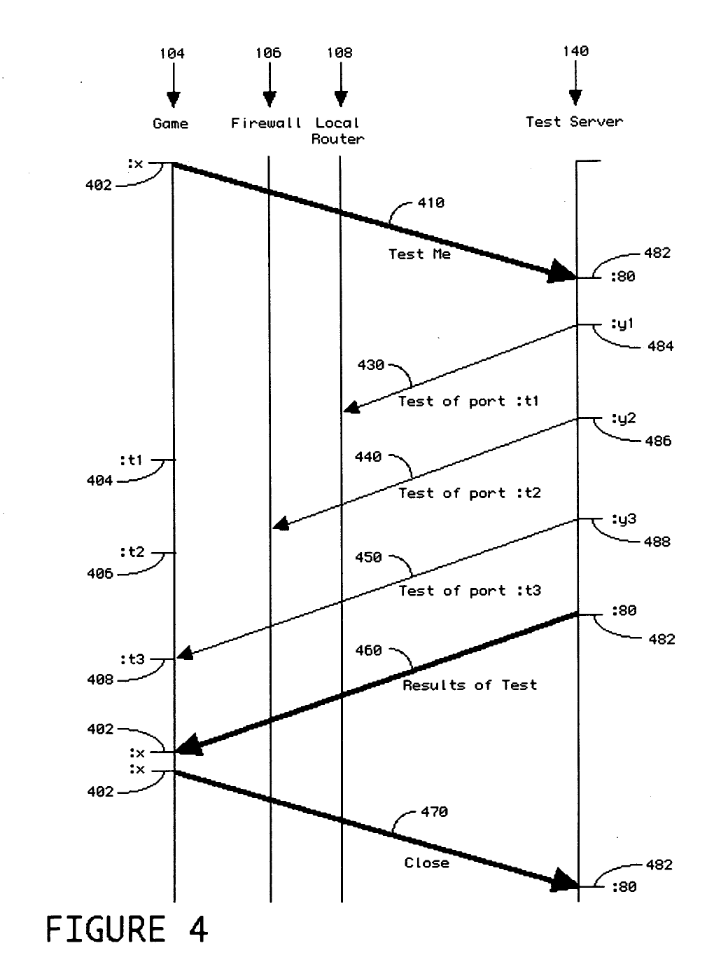

FIG. 4 is a diagram of the transactions that take place between application 104 and test server 140 during an execution of target test process 200 and server test process 300. In this diagram, application 104 requires inbound traffic on UDP ports :t1 402, :t2 404, and :t3 406. Communication is established by application 104 with test server 140 in step 206, using the preferred HTTP protocol over TCP/IP to port :80 482 of test server 140, from arbitrary TCP port :x 402 on computer 102, provided by the protocol stack 107 to application 104. These comprise the parameters of the request 410 sent in step 206.

Note that the detailed transaction of initiating and later terminating the TCP connection, and any transport layer acknowledgements or retransmission, all well known in the art, are not shown here. However, messages 410, 460, and 470 are conducted over this TCP connection, and appear bold in FIG. 4. The other messages 430, 440, and 450 are UDP transmissions, and are not bolded in FIG. 4.

Upon receipt of message 410, at port :80 482, of test server 140, in step 312, test server process determines in step 314 that the request is for a predefined test, and obtains the list of ports and protocols in step 318. Since there are three ports to be tested, the loop comprising steps 320, 322, 324 and 326 iterates three times.

In the first iteration of the loop, in step 322, test server process 300 opens arbitrary UDP port :y1 484, and sends message 430 to the address of station 100, port :t1 404. However, due to a configuration error in router 108, the message does not passed to computer 102. The monitor process 210 corresponding to port :t1 never receives the event of corresponding step 212. It could be the case that router 108 was configured to forward port :t1 to additional computer 102′, a very common error in households having multiple computers used at various times to play the same game online, in which case the message likely would be dropped by the protocol stack (not shown) on computer 102′, for lacking an application with that port open.

In the second iteration of the loop, again in step 322, test server process 300 opens arbitrary UDP port :y2 486, and sends message 440 to the address of station 100, port :t2 406. In this case, router 108 is correctly configured, and the message is passed to computer 102. However, due to a configuration error in firewall 106, the message is suppressed before it reaches application 104. The monitor process 210 corresponding to port :t2 never receives the event of corresponding step 212.

In the third iteration of the loop, again in step 322, test server process 300 opens arbitrary UDP port :y3 488, and sends message 450 to the address of station 100, port :t3 408. In this case, router 108 is correctly configured, and the message is passed to computer 102. Firewall 106 is also correctly configured, and the message is passed to application 104, where monitor process 210 corresponding to port :t3 receives the event of corresponding step 212, and in step 214 marks port :t3 as operational.

Having exited the loop, test server process 300 reports the results of the test with message 460 in step 330. The message 460 is received in step 208 by target test process 200, which preferably responds with a polite close message 470 to expedite the termination of the test server process 300.

The contents of the results message 460, in the case of UDP port tests, can be nothing more than an acknowledgement that the test was performed. However, if the tests requested included TCP ports, most sophisticated error messages could be provided. Further, in the alternate embodiment discussed where outbound ports could be tested, results message 460 would also include the results of outbound port tests.

In executing loop comprising steps 220, 222, 224, 226, 228, ports :t1 and :t2 which failed their test are closed and their corresponding monitor processes 210 are terminated. Port :t3 passed its test and should already be closed and corresponding monitor process 210 already concluded.

Since failures are detected in step 230, remedies and informational resources are provided in step 232. In particular, advice that ports :t1 and :t2 need to be admitted by firewall 106 and forwarded by router 108 should be provided. Even though port :t2: is correctly forwarded by router 108, as tested by message 440, neither application 104 nor test server 140 is aware of this, and so the advice covers both candidate causes for failure. Whether the firewall 106 is correctly configured for port :t1 is neither determined nor detected by this test.

As a result of the lack of total success, as determined at step 230, the application 104, having provided advice and/or resources in step 232, exits in step 234. Once the operator of station 100 has undertaken some or all of the advice provided, re-launching application 104 stands a better chance of finding that station 100 is successful configured.

While the preferred embodiment is discussed in the context of present day communications channels and protocols, it is contemplated that other modes of communications and interconnection will be suitable as they are made available.

The particular implementations described, and the discussions regarding details, and the specifics of the figures included herein, are purely exemplary; these implementations and the examples of them, may be modified, rearranged and/or enhanced without departing from the principles of the present invention.

The particular features discussed regarding the user interface and the performance of the application, will depend on the architecture used to implement a system of the present invention, the operating system of the computers selected, the communications channel selected, and the software code written. It is not necessary to describe the details of such programming to permit a person of ordinary skill in the art to implement an application and user interface suitable for incorporation in a computer system within the scope of the present invention. The details of the software design and programming necessary to implement the principles of the present invention are readily understood from the description herein.

As an empirical example, a single programmer implemented the entirety of test server process 300 in several hours by writing a PERL wrapper around the free software product Nmap, a versatile, free software application written by a programmer under the name (pseudonym?) of Fyodor. Nmap is widely available and supported at www.insecure.org/nmap. Testing of the test server process 300 could be performed by accessing the URL of the PERL script with an unmodified browser, and examining intervening firewall logs for inappropriate UDP traffic captures. A second programmer, making use of the newly provided test server successfully implemented target test process 200, again within several hours, resulting in a complete implementation suitable for release embedded within an actual application.

Various additional modifications of the described embodiments of the invention specifically illustrated and described herein will be apparent to those skilled in the art, particularly in light of the teachings of this invention. It is intended that the invention cover all modifications and embodiments, which fall within the spirit and scope of the invention. Thus, while preferred embodiments of the present invention have been disclosed, it will be appreciated that it is not limited thereto but may be otherwise embodied within the scope of the following claims.

I claim as my invention:

1. A system for determining whether a first connection to a network is suitable for use by a first application before actual use by said first application, said first application executable on a first computer, said first connection comprising a second connection between said first computer and said network, said system comprising:
a test server having a third connection to said network,
a test process that runs on said first computer, said test process able to access said first connection, said test process further being in communication with said test server, whereby said test process directs said test server to attempt an exchange of at least one test message, said at least one test message selected to provide a first evaluation of said first connection for use by said first application.

2. The system of claim 1 wherein said first application comprises said test process.

3. The system of claim 1 wherein a second application comprises said test process.

4. The system of claim 1, where in said network is the Internet.

5. The system of claim 1, wherein said second connection comprises a first device operatively connected between said network and said first computer, said first device selected from the group composed of a first router, a first firewall, and a modem.

6. The system of claim 5, wherein said first device has a first configuration, and said at least one test message further provides a second evaluation of said first configuration.

7. The system of claim 5, wherein said second connection further comprises a second device operatively connected between said first device and said first computer, said second device selected from the group composed of a second router and a second firewall.

8. The system of claim 1, wherein a portion of said first connection exclusive of said second connection comprises a first software able to run on said first computer.

9. The system of claim 8, wherein said first software comprises a protocol stack.

10. The system of claim 8, wherein said first software comprises a second firewall.

11. The system of claim 1, wherein said first application requires said first connection to support inbound messages on a first protocol port, said first connection further comprising said first protocol port, and said first protocol port is monitored by said test process on said first computer, and wherein said exchange comprises an message directed from said test server to said first protocol port;
whereby said exchange can determine the operation of said first protocol port.

12. The system of claim 11 where said first protocol port is a UDP port.

13. The system of claim 11 where said first protocol port is a TCP port.

14. The system of claim 1, wherein said first application requires said first connection to support outbound messages on a second protocol port, and wherein said test process comprises an outbound message emitted from said second protocol port to said test server, wherein said test server reports back to said test process upon receipt of said outbound message.

15. The system of claim 14 where the second protocol port is a UDP port.

16. The system of claim 14 where the second protocol port is a TCP port.

17. A method for determining whether a first connection from a computer to a network is suitable for use by a first application on said computer before use by said first application, comprising the steps of:
a) providing a test server operably connected to said network;
b) providing a test process on said computer;
c) preparing said first connection for use by said test process;
d) directing said test server with said test process to attempt an exchange of at least one test message, said test server being operatively connected to said network and said at least one test message selected to provide an evaluation of said first connection;
e) monitoring said first connection with said test process for receipt of said at least one test message;
f) determining at a conclusion whether each of said at least one test message was received; and,
g) releasing said first connection for use by said application after said first connection is determined to be suitable for use by said first application.

18. The method of claim 17, wherein said conclusion occurs at the earlier of receiving each of said at least one test message, a timeout, and receiving a result from said test server.

19. The method of claim 17, further comprising the step of:
h) providing predetermined diagnostic information associated with at least one of said at least test message that was not received.

20. The method of claim 19, further comprising the step of:
i) repeatedly performing steps d), e), f), and h) until in determining step f) each of said at least one test message was received.
